(19) United States
(12) Patent Application Publication
(10) Pub. No.: US 2022/0111314 A1
(43) Pub. Date: Apr. 14, 2022

(54) A WATER FILTRATION DEVICE

(71) Applicant: KLT FILTRATION LIMITED, King's Lynn Norfolk (GB)

(72) Inventors: Stuart Crispin MORRIS, King's Lynn Norfolk (GB); Sean Ashley ELLIS, King's Lynn Norfolk (GB)

(21) Appl. No.: 17/298,335

(22) PCT Filed: Dec. 2, 2019
(86) PCT No.: PCT/EP2019/083363

§ 371 Date: May 28, 2021

(30) Foreign Application Priority Data
Nov. 30, 2018 (GB) 1819592.5

(51) Int. Cl. B01D 29/33; B01D 29/58; B01D 35/04; B01D 35/143; B01D 39/20; C02F 1/00; C02F 1/50; C02F 1/28

(52) U.S. Cl. CPC B01D 29/33; C02F 2303/04; B01D 35/04; B01D 35/143; B01D 39/2075; B01D 39/2062; C02F 1/003; C02F 1/50; C02F 1/288; C02F 2307/06; B01D 2239/0442; B01D 2239/065; B01D 2239/1216; C02F 1/281; C02F 1/283; C02F 2201/003; C02F 2201/006; C02F 2209/445; B01D 29/58

(57) ABSTRACT

A filter to remove contaminants from potable water. The filter comprises a plurality of porous layers 15,16 forming a fluid path for the water to pass sequentially from the first layer 16 through the layers to the final layer. The first layer 16 is formed of a ceramic and/or sintered material and includes a virucide. Said first layer 16 is distinguishable from an adjacent second layer 15, wherein at least one of the first and second layers 16, 15 comprises a dye material.

### FIELD OF THE INVENTION

The present invention relates to a filter to purify water, specifically drinking water. In particular, the device is suitable for use incorporated as part of the domestic water supply.

### BACKGROUND OF THE INVENTION

The provision of clean drinking water is extremely important to the health of individuals. Most domestic water supplies in developed countries supply water to a good standard, defined in law. However, this is not always the case, and in any event some people prefer or need an even higher level of purity and cleanliness than that which is provided. For example, a health condition might require that certain chemicals or microorganisms which remain or find a way into the water, be removed. Additionally, a user might not be satisfied with the level of cleanliness and purity provided by a water source due to the unknown long term health effects of long term exposure to specific water contaminants. Recently, it has been a topic of much debate as to the extent to which micro plastic material found in the food chain and water cycle will effect long term health.

There is a substantial diversity of potential contaminants that can be found in different water sources. There is equally a wide variation of contaminant concentration and these concentrations also vary over time.

With respect to the contaminant group of microorganisms where the health effects are understood, the consequence of exposure can vary from relatively minor stomach upsets to the much more critical and often terminal infectious bacterial diseases such as cholera.

Microorganisms which are harmful to health can vary in size from 0.02 μm to 2 μm. To guarantee that a filter will remove or eliminate microorganisms completely from effluent drinking water requires that a filter structure is of a pore size of 0.02 μm. Guaranteed uniform material pore sizes in this range are not accepted as achievable and so consequently virucides are added to the filter.

Filters with a pore size in the range of 0.02 to 0.5 μm substantially restrict the water flow at normal water pressures of between 2 and 4 bar (200-400 kPa) making the filter impractical to use in a domestic environment.

Water sources that are at risk of harmful microorganisms often contain a large proportion of solid contaminant, particularly organic materials, which attach to the surface of a filter and reduce the amount of water which can pass through the filter, thus making them impractical to use in a domestic environment. To extend the life of a filter of a ceramic or sintered construction it is often necessary to clean the filter from time to time. Although chemical cleaners can be used, this is inefficient and potentially damaging to the user or the environment, and so cleaning is typically carried out by the use of an abrasive to rub away the top layer of the filter, including the contaminant. The disadvantage of this method is that over time the filter structure reduces in thickness. A filter with greater than 0.2 μm pore size no longer becomes effective at safely removing microorganisms once it reaches a critical thickness.

Furthermore, there is no easy and effective way of warning the user that the filter has reached a critical thickness beyond which it becomes unsafe to continue to clean and reuse the filter.

It is an object of the present invention to provide a system which addresses the above problem.

### SUMMARY OF THE INVENTION

According to the invention, there is provided a filter to remove contaminants from potable water, the filter comprising a plurality of porous layers forming a fluid path for the water to pass sequentially from the first layer through the layers to the final layer, wherein the first layer is formed of a ceramic and/or sintered material and includes a virucide and further that said first layer is distinguishable from an adjacent second layer, wherein at least one of the first and second layers comprises a dye material.

The filter may be a tubular candle shape or other geometry, for example a flat sheet, disc or sphere. The filter in particular removes microorganisms and other microbiological contaminants, but potentially other, contaminants from potable water at an acceptable flow rate.

The filter ceramic may be produced from a hybrid porous ceramic or other sintered material compromising a plurality of layers of controlled thickness. The term “hybrid” refers to the porous ceramic/sintered material being formed as a single piece, but having at least two distinct layers having different properties, said properties including different pore sizes, which is created during the manufacturing process. At least one of the plurality of layers is coloured with a dye to clearly identify the boundaries within the structure. The dye may be added at a stage when the ceramic is a fluid slip before it is fired This has a number of possible benefits to users of the filter. In particular, the dye provides a warning to the filter user of the need to replace a filter at a point where repeated cleaning cycles are likely to render the filtered water unsafe to drink. A further advantage by having a dye which clearly demarcates the boundary of the layers is in quality control since it is clear whether the process to produce the This ceramic or other sintered material forms a fluid path for the water to pass sequentially from the first layer through the layers to the final layer. In the case of a tubular-shaped filter candle, the final layer may be an inner layer and the first layer may be the outer layer. The water may then either pass through an additional component, such as granular or rodded carbon, or directly exit the filter through an outlet.

Preferably, the first layer is formed of a sub-micrometre pore size ceramic or sintered material that includes a virucide and a dye consequently that said first layer is distinguishable from an adjacent second layer of the ceramic or sintered material and indicates the limits of the layer thickness. The first layer may have a large pore size than the second layer. The first layer may act not only as an indicator i.e. to show when it is time to replace the filter or that the manufacturing process was faulty, but also act as a first filter layer to remove larger material such as organic material, and also kill some viruses due to the presence of the virucide.

Preferably the second layer, which may be termed a working layer as that is where the majority of the filtration will occur, is also formed of a sub-micrometre pore size porous ceramic or sintered material that includes a virucide but either contains a different colour dye to that of the first layer or does not contain a dye in the instance that the natural, undyed colour of the second layer is a different colour to the dye of the first layer so as to remain distinguishable.

The inner ceramic/sintered layer (which may be the second layer if there are two layers) preferably has a pore size which is sufficiently small to prevent bacteria and viruses and particles of a similar size from passing therethrough, whereas the outer ceramic layer has a pore size equal to or greater than those present in the inner ceramic layer, which are sufficiently small to prevent the passage of viruses. The inner and outer ceramic layers are porous in nature, having a mean pore size as measured by mercury porosity, of from 0.6 to 1.1 μm, preferably 0.7-1.0 μm. The mean pore size of the outer ceramic layer is preferably equal or greater than that of the inner ceramic layer.

A third and any successive layers (which may be layers or structural layers) may be engineered to exhibit further desired properties, for example they may comprise large micrometre pore-sized structures to provide greater structural rigidity of the filter. These further layers may also be dyed in a colour different from the first or second layers to identify their boundaries.

The thickness of the second layer is determined from a combination of the ceramic mean pore size, filter surface area in contact with the influent water, the water volume flow rate, the expected influent concentration of contaminants or that specified within a filter testing standard and the designed volume life of water for the filter—for example 10000 L.

The first layer, which may be considered a sacrificial layer, is intended to maximise the life of the second layer. Influent solid particle and organic material contamination levels in the water of the market or region the filter is intended to operate in may be assessed. Alternatively, the level of influent contaminates can be specified from a filter test specification standard. In either case this data is used to determine the optimum ceramic pore size and the number times that the filter will have to be cleaned during the life of the second layer. The pore size of the first layer is selected to provide the appropriate residence time and surface area for the effective action of the virucide. The thickness of the first layer may be calculated from the thickness reduction from the anticipated number of cleaning cycles, taken from empirical data.

The third and subsequent layers, where provided, can be determined through similar calculations specific to the properties intended for that layer, i.e. whether they are to be further filtering layers or structural layers.

Once the first layer has abraded through cleaning to an extent that the first layer is no longer preventing viable viruses from penetrating through to the second layer, then this is evidenced by the colour of the second layer becoming visible through the first layer.

Overall the controlled colour of subsequent layers with differing properties enables the engineering of what would otherwise be a uniformly coloured ceramic or sintered material such that the user can safely operate and clean the filter to provide safe drinking water.

### BRIEF DESCRIPTION OF THE DRAWINGS

The invention is illustrated with respect to the accompanying drawings which show, by way of example only, two embodiments of the filter. In the drawings:

FIG. 1 illustrates diagrammatically a filter candle in accordance with a first embodiment of the invention;

FIG. 1a illustrates diagrammatically a filter candle in accordance with a second embodiment of the invention;

FIG. 2 is a perspective view of the first embodiment of the invention;

FIG. 3 is a perspective view of a third embodiment of the invention;

FIG. 4 is a longitudinal section through the filter candle of FIG. 2;

FIG. 5 is a longitudinal section through the filter candle of FIG. 3;

FIG. 6 is a perspective view of the filter candle of FIG. 3;

FIG. 7 is a longitudinal section through the filter candle of FIG. 6;

FIG. 8 is a section through the inner and outer ceramic layers;

FIG. 9 is an electron micrograph of the site marked ‘X’ in FIG. 8; and

FIGS. 10 and 11 illustrate use of a filter candle in accordance with an embodiment of the invention.

### DETAILED DESCRIPTION OF THE INVENTION

The requirement to filter chemicals along with viruses and small organisms from water being supplied for domestic usage is becoming increasingly important. Although in most first world countries the domestic water supply is supposed to comply with defined legal standards concerning materials dissolved or suspended therein, such standards are not always met, either on a temporary basis (due to malfunction of a cleaning system) or also because of systemic deficiencies in a purification plant due to lack of competence or lack of effective public oversight of the process. In non-first world countries, the risk of drinking unsuitable water is even greater. Many people choose therefore to install their own purification systems, at the point of drawing off the water from the mains supply. This provides them with greater control over the water they drink, but increases the maintenance they personally need to undertake.

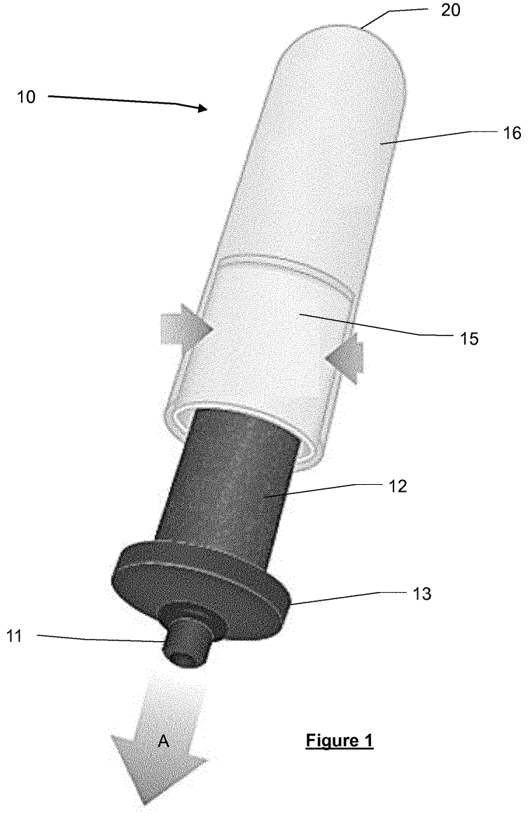

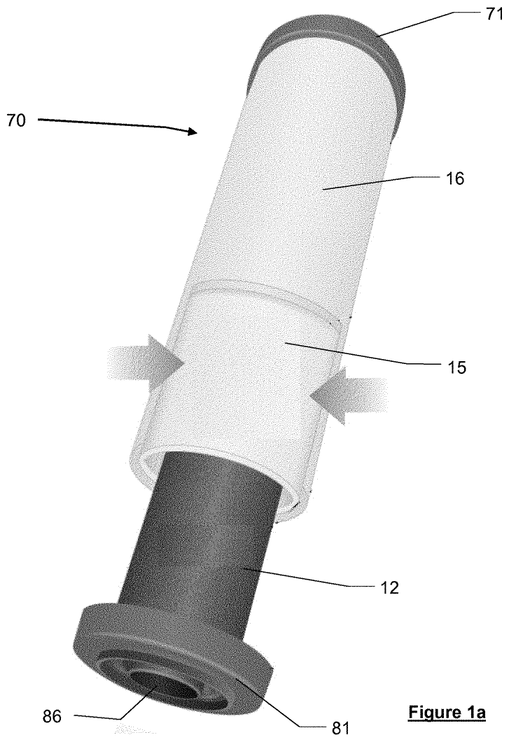

There are many systems of varying effectiveness, available for carrying this out, such as the use of magnetic fields disposed about a pipe, beads to remove unwanted salts etc. The present invention contemplates a different system involving a filter, a non-limiting example of which is often referred to as a candle, and which is figuratively illustrated in FIG. 1. Alternative shapes of filter, such as flat sheets or discoid or spherical filters, are also contemplated.

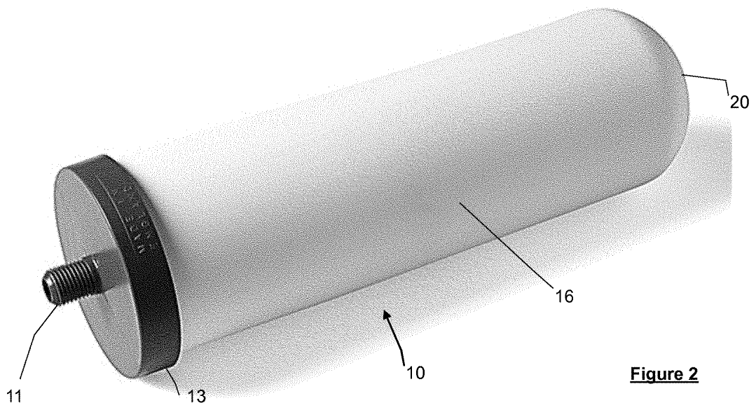

FIG. 1 is an exploded view of a filter candle 10, which Figure shows the main component parts. The assembled candle 10 is shown in FIG. 2 and is designed and placed within the water stream such that the water flows from the outside of the candle 10, passing through the different layers discussed below, before exiting through the outlet 11 as shown by arrow A. The different layers are structured and assembled together that the water has to pass through each before it can exit. In this manner therefore, all the water is treated by each layer, ensuring that unwanted constituents are removed.

In broad outline therefore, the candle 10 comprises a central, generally cylindrical filter element 12 formed of carbon banded to a first end-cap 13 in a fluid tight manner along a first edge, with the hollow core of the element 12 being fluidly connected to the outlet 11 of the end-cap 13. Surrounding the element 12 is an inner ceramic/sintered layer 15, which is also bonded at one end to the first end-cap 13 in a fluid-tight manner. An outer ceramic/sintered piece comprising an outer ceramic/sintered sacrificial layer 16 surrounding the inner layer 15 which optionally may surround, where applicable, either a further working or structural layer, is again bonded at one end, in a fluid-tight manner to the first end-cap 13. In general terms the element 12 acts to filter out microorganisms as well as soluble chemicals from the water supply such as heavy metals, organic chemicals, pesticides and herbicides, pharmaceuticals etc. The inner ceramic/sintered layer 15 comprises either a separate bespoke ceramic or sintered material which acts to filter out microorganisms and/or a specific chemical or group of chemicals or acts purely as a structural agent to support the outer two layers.

The inner ceramic/sintered layer 15 has a pore size which is sufficiently small to prevent bacteria and viruses and particles of a similar size from passing therethrough. The outer ceramic layer 16 has a pore size equal to or greater than those present in the inner ceramic layer 15, which are sufficiently small to prevent the passage of viruses.

It can be seen therefore that the three layers, including the carbon layer 12, will combine together to remove most unwanted impurities from the water.

In the embodiment of FIG. 2, the end 20 of the candle 10, distal to the first end-cap 13 is formed of the ceramic materials of the inner and outer ceramic/sintered layers, 15, 16 and is co-extensive therewith to close off the end of the candle 10.

In more detail, the inner and outer ceramic layers 15, 16 are porous in nature, having a mean pore size as measured by mercury porosity, of from 0.6 to 1.1 μm, preferably 0.7-1.0 μm. The mean pore size of the outer ceramic layer 16 is preferably equal or greater than that of the inner ceramic layer 15. The proportion of lower size to higher size pores needs to be controlled as pores of smaller size are more easily blocked and also resist more strongly flow of water through the pores.

As exemplified thicknesses of the inner and the outer ceramic layers 15, 16, under normal operation of a candle and a water pressure of 2.4 bar (240 kPa) to give a flow rate of 2.5 l/min, then the inner ceramic layer is from 4.6 mm in thickness and preferably 4.5-5.5 mm and further preferably 4.9-5.1 mm. The outer ceramic layer 16 is usually thinner than the inner ceramic layer 15 for the reasons stated above with a thickness of 4 mm, preferably 3.5 mm, further preferably <3.0 mm.

To improve the virucidal properties of the inner and outer ceramic layers 15 and 16, a biocide such as a virucide is included within the ceramic material of the outer ceramic/sintered layer 16. An example of a suitable biocide is Biocoat™. An advantage of there being a filter element 12 formed of carbon is that the use of a biocide can be confined to the ceramic component to minimise the risk that the biocide might seep more easily into the water being purified.

Additionally, the outer ceramic layer 16 is provided with a feature which enables the outer ceramic layer 16 to be readily visually distinguished from the inner ceramic layer 15.

As the candle 20 is used it will require cleaning from time to time on the outside, using an abrasive cleaner. This cleaning is carried out to remove contaminant particulate material which becomes caught in the outer pores and thus prevents flow of liquid through the outer ceramic layer 16 and also provides surface area and nutrients to support microbial growth, which is obviously undesirable. As such, each time the contaminant is removed a layer of the outer ceramic layer 16 is also abraded and over time the thickness of the outer ceramic layer 16 becomes reduced. Enabling the layers 15, 16 to be visually distinguished allows a ready check to be carried out as to whether the candle needs to be replaced.

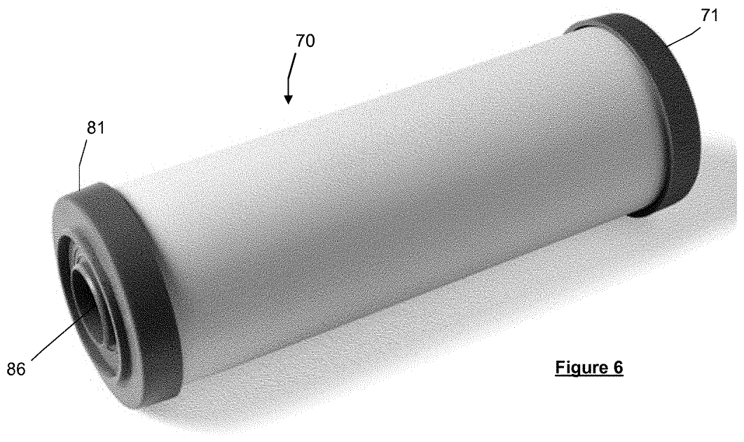

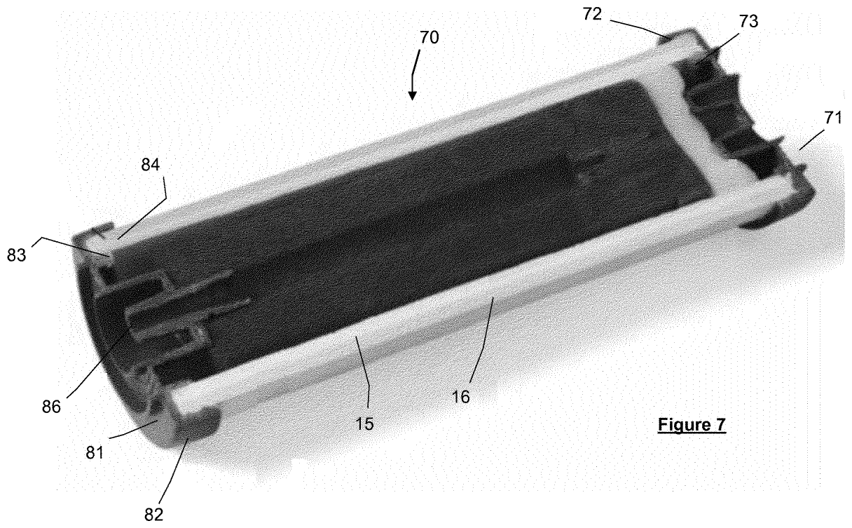

FIGS. 6 and 7 illustrate a second embodiment of a filter candle 70. This embodiment has the advantage of providing a higher surface area of a porous nature. The candle 70 is generally cylindrical having an end-cap 71, including outer and inner walls 72, 73 to frictionally engage the ends of the inner and outer ceramic layers 15, 16. This embodiment of candle 70 can be of larger dimensions than those of the first embodiments.

Further end-cap 81, similarly to the end-cap 13 of the first embodiment, has outer and inner retaining walls 82, 83 to form a channel 84 which retains the inner and outer ceramic layers 15, 16 of the candle 70. End cap 81 is further provided with an outlet 86 through which filtered liquid exits the candle 70.

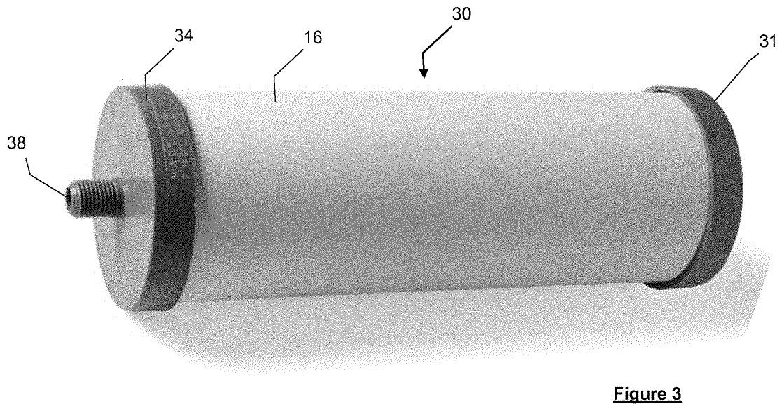

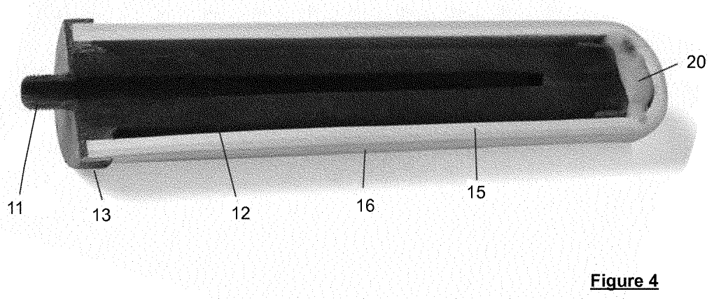

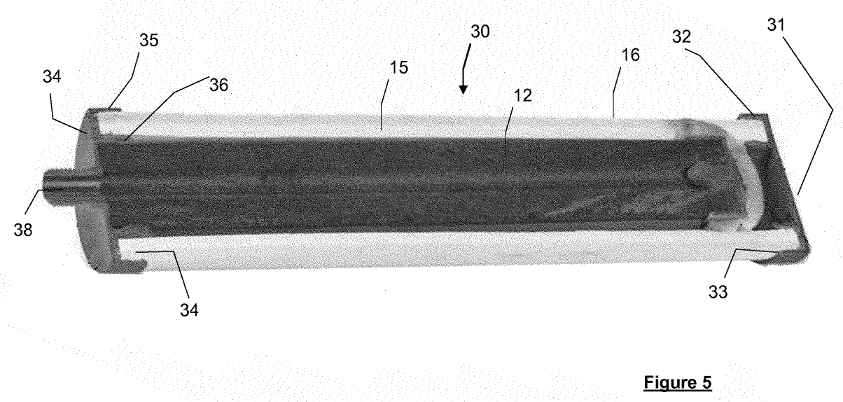

FIGS. 3 and 5 illustrate a third embodiment of a filter candle 30. The candle 30 is generally cylindrical having an end-cap 31, including outer and inner walls 32, 33 to frictionally engage the ends of the inner and outer ceramic layers 15, 16. This embodiment of candle 30 can be of larger dimensions than those of the first embodiment.

Further end-cap 34, similarly to the end-cap 13 of the first embodiment, has outer and inner retaining walls 35, 36 to form a channel 37 which retains the inner and outer ceramic layers 15, 16 of the candle 30. End cap 34 is further provided with a threaded outlet 38 through which filtered liquid exits the candle 30.

A dye is be incorporated into one or both layers, 15, 16 to distinguish them. Several additional alternatives are also available to allow the layers 15, 16 to be distinguished. To reduce costs, then only one of the layers 15, 16 is dyed. Once the outer ceramic layer 16 has been worn away, the inner ceramic layer 15 will show through, since it is a different colour, to provide the required indication that a new filter is needed. The outer ceramic layer 16 will need changing after a number of cleaning cycles. Alternatively, a layer 15, 16 can be dyed to given a patterned configuration, either by altering the structure of a layer and/or including pigmentation.

The inner ceramic layer and outer ceramic layer 15, 16 are preferably held in contiguous relationship to aid water transfer between the two layers.

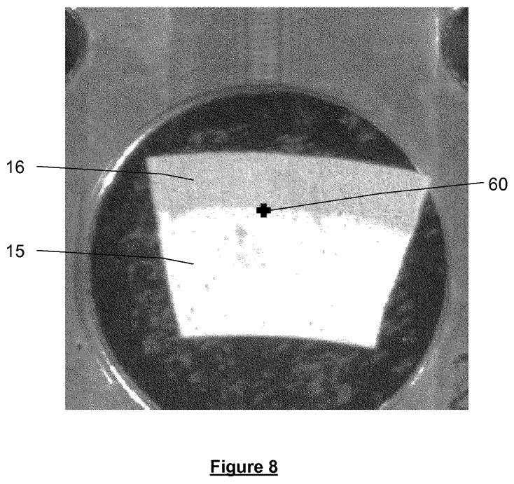

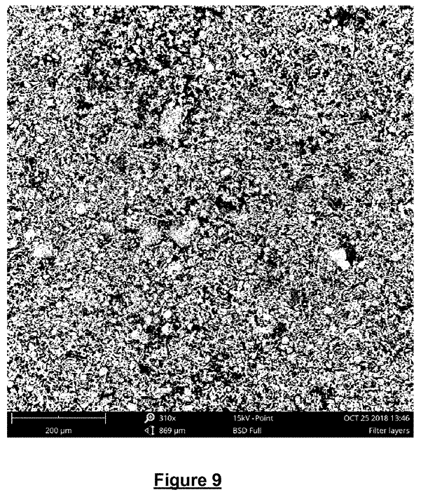

Further preferably, the two layers interpenetrate each other, which can be achieved for example by forcing the two layers together whilst their engaging surfaces are still wet, thus giving an indistinct boundary layer once the water is removed. Alternatively or additionally, the inner ceramic layer and outer ceramic layer 15, 16 can be formed together using a multi-stage, variable pressure, high pressure casting process. The advantage of the interpenetration is that there is then a reduced tendency for the inner ceramic layer and outer ceramic layer 15, 16 to crack or split, something which would lead to failure of the filtration unit. The interpenetration can be seen from FIGS. 8 and 9. FIG. 8 shows a section through a ceramic wall material, and the distinguishing colours of the inner ceramic layer 15 and outer ceramic layer 16 can be seen. A marker ‘X’ 60, indicates the position at which the electron micrograph of FIG. 9 (x310) is taken, on the line joining the two layers 15, 16. It can be seen that there are no features to readily define a ‘border’ between the layers 15, 16, other than the colour difference (not shown in FIG. 9), and that they are intermixed.

The inner ceramic layer 15 and the element cylinder 12 are optionally held in spaced relationship to each other. Without being bound to theory, it is believed that a gap helps the water to flow out more evenly given the irregular structure of the inner ceramic layer 15 and the central element.

The compositions of the ceramic materials from which the inner ceramic layer 15 and the outer ceramic layer 16 can be formed are set out below in Tables 1 and 2.

TABLE 1
Constituents of inner ceramic layer

| Constituents | Amounts (% w/w) |
|---|---|
| Diatomaceous earth | 27-31 |
| Silver powder | 0.01-0.02 |
| Ball clay | 3.7-6.10 |
| Dispex (RTM) | 0.005-0.009 |
| Quartz | 1.00-1.5 |
| Water | 68.28-61.37 |
| Total | 100% |

TABLE 2
Constituents of outer ceramic layer

| Constituents | Amounts (% w/w) |
|---|---|
| Diatomaceous earth | 26.00-29.00 |
| Biocoat (RTM) | 0.04-0.06 |
| Blue stain | 4.00-6.00 |
| Ball clay | 3.50-5.90 |
| Dispex (RTM) | 0.0050-0.0090 |
| Quartz | 0.910-1.4 |
| Water | 65.55-57.63 |
| Total | 100% |

In the above, Dispex® is a polyacrylate polymer, typically based on the monomer ammonium acrylate.

Utilising the above arrangement, then the following reductions in harmful materials have been achieved for 4000 l feed of water.

TABLE 3
Reduction in microorganism contaminant

| Contaminant | Reduction (%) at 3000 litres |
|---|---|
| Klebsiella terrigena | >99.9999 |
| Cryptosporidium spp. | >99.9 |
| Rotavirus spp. | >99.9 |

TABLE 4
Reduction in contaminant heavy metals

| | Influent Challenge | Reduction |
|---|---|---|
| Metal contaminant | (μg/l) | (%) |
| Aluminium | 3185.0 | >99.9 |
| Arsenic (5+) | 50.2 | 93.8 |
| Cadmium | 30.2 | >99.9 |
| Chromium | 30.4 | >99.7 |
| Copper | 3059.0 | 99.3 |
| Lead | 152.0 | >99.9 |
| Mercury | 6.1 | >99.9 |
| Thallium | 6.0 | >99.9 |

TABLE 5
Reduction in inorganic contaminant

| | Influent Challenge | Reduction |
|---|---|---|
| Inorganic contaminant | (μg/l) | (%) |
| Chlorine (free) | 2150 | >99.9 |
| Chloramine | 3100 | >99.9 |
| Chloride | 820000 | 96.6 |
| Nitrate | 27000 | 95.6 |
| Nitrite | 3000 | >99.9 |

TABLE 6
Reduction in volatile and semi-volatile organic contaminant

| Volatile and semi-volatile | Influent Challenge | Reduction |
|---|---|---|
| organic contaminant | (μg/l) | (%) |
| Vinylchloride | 43.23 | >99.8 |
| Carbon tetrachloride | 88.50 | >99.9 |
| Benzene | 80.50 | >99.9 |
| 1,1-trichloroethane | 84.8 | >99.9 |
| Toluene | 78.30 | >99.9 |
| Styrene | 150.00 | >99.9 |
| 2-chlorotoluene | 10.08 | >99.9 |
| 2,3-dichlorobenzene | 80.20 | >99.9 |
| Naphthalene | 160.20 | >99.9 |
| Ethylene dibromide (EDB) | 44.80 | >99.9 |
| Bromoacetonitrile | 22.00 | >99.9 |
| anthracene | 49.8 | >99.9 |
| Fluorene | 47.9 | >99.9 |
| Hexachlorobenzene | 50.2 | >99.9 |
| Phenol | 50.9 | >99.9 |
| Nitrobenzene | 48.3 | >99.9 |
| 4-nitrotoluene | 47.5 | >99.9 |
| Diethylphthalate | 49.2 | >99.9 |
| Pyrene | 49.7 | >99.9 |

TABLE 7
Reduction in pesticide and herbicide contaminant

| Pesticide/herbicide | Influent Challenge | Reduction |
|---|---|---|
| contaminant | (μg/l) | (%) |
| Chlorothalonil | 51.2 | >99.9 |
| chloropyrifos | 50.6 | >99.9 |
| 2,4-D | 50.1 | >99.9 |
| Glyphosphate | 804.2 | >99.9 |
| p,p-DDT | 60.5 | >99.9 |
| Dichlorvos | 52.3 | >99.9 |
| Aldrin | 46.8 | >99.9 |

TABLE 8
Reduction in pharmaceutical contaminant

| | Influent Challenge | Reduction |
|---|---|---|
| Pharmaceutical contaminant | (μg/l) | (%) |
| Ibuprofen | 0.45 | >99.9 |
| Caffeine | 1.82 | >98.9 |
| Testosterone | 1.44 | >99.9 |
| Progesterone | 2.08 | >99.9 |
| Trimethoprim | 2.20 | >99.9 |
| Acetaminophen | 2.42 | >99.2 |
| Diclofenac Sodium | 1.90 | >99.9 |
| Carbamazepine | 1.43 | >99.9 |

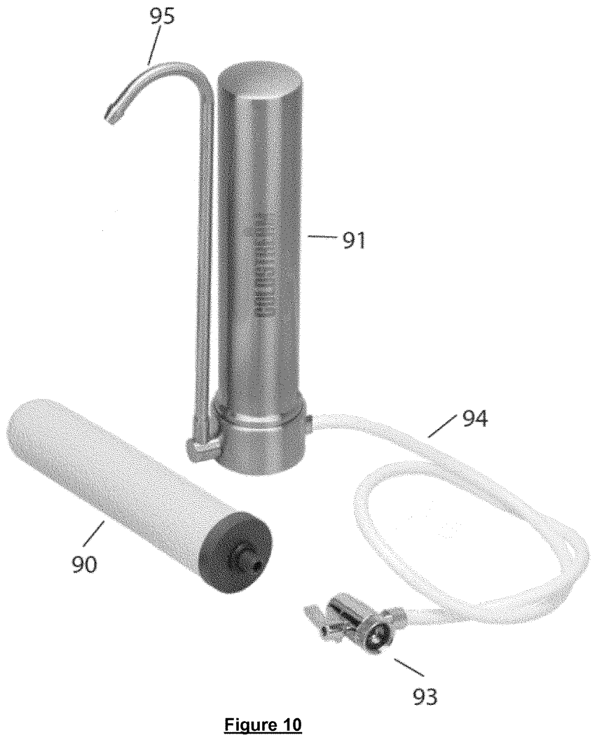

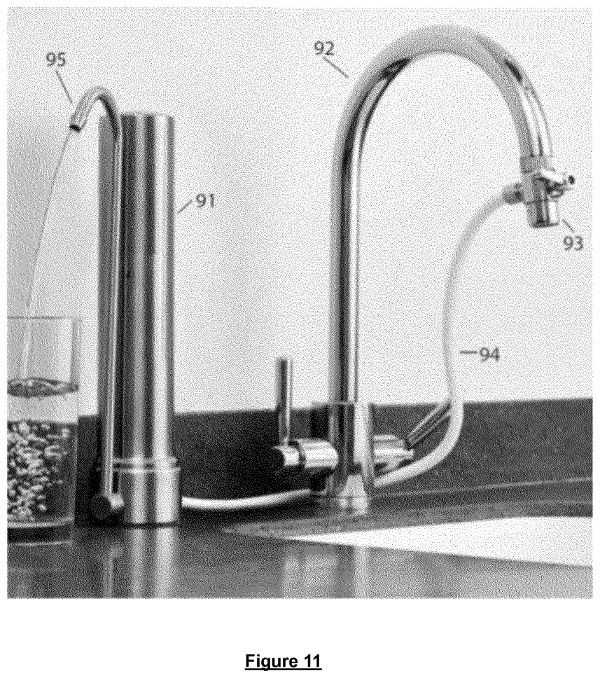

In use therefore, a device in accordance with the above described embodiments is inserted between a mains supply and a user. For example, FIGS. 10 and 11 illustrate a means of utilising the invention. Here, a device 90 is shown, which in use is housed within the casing 91. The casing 91 is connected to the tap 92 by a specially adapted connector 93 and a flexible tube 94. The device 90 is inserted into an aperture (not illustrated) within the casing 91. The aperture is fluidly connected to the outlet 95.

1. A filter to remove contaminants from potable water, the filter comprising a plurality of porous layers forming a fluid path for the water to pass sequentially from the first layer through the layers to the final layer, wherein the first layer is formed of a ceramic and/or sintered material and includes a virucide and further that said first layer is distinguishable from an adjacent second layer, wherein one or both of the first and second layers comprises a dye material.

2. A filter as claimed in claim 1, wherein the filter is a tubular filter candle, a flat sheet, disc or sphere.

3. A filter as claimed in claim 2, wherein the second layer is also formed of a ceramics material.

4. A filter as claimed in claim 3, wherein the second layer includes a bactericide.

5. A filter as claimed in claim 1, wherein the first and second ceramic/sintered layers have a mean pore size of from 0.6 to 1.1 μm, preferably 0.7-1.0 μm.

6. A filter as claimed in claim 1, wherein the mean pore size of the first layer is equal or greater than that of the second layer.

7. A filter as claimed in claim 1, wherein a third layer is formed of carbon.

8. A filter as claimed in claim 7, wherein the third layer is in the form of a hollow cylinder, open at both ends.

9. A filter as claimed in claim 1, wherein the virucide is the virucide “Biocoat”™.

10. A filter as claimed in claim 1, wherein the layers are formed into a cylindrical filter body.

11. A filter as claimed in claim 10, wherein the cylindrical filter layers are housed at a first end in a first end-cap.

12. A filter as claimed in claim 11, wherein the first end-cap includes one or more channels defined by channel walls.

13. A filter as claimed in claim 12, wherein cylindrical filter layers are housed at a second end by a second end-cap.

14. A filter as claimed in claim 13, wherein a second end-cap including one or more channel, defined by channel walls.

15. A filter as claimed in claim 14, wherein a resilient layer is provided between the carbon layer arid the second end-cap.

16. A filter as claimed in claim 1, wherein the material of the first and second ceramic layers interpenetrate each other.

17. A filter as claimed in claim 1, further comprising an outlet adjacent the final layer, wherein water passing through the final layer exits the filter through the outlet.
